(19) United States
(12) Patent Application Publication
(10) Pub. No.: US 2011/0165361 A1
(43) Pub. Date: Jul. 7, 2011

(54) OPTICAL ADHESIVE WITH DIFFUSIVE PROPERTIES

(76) Inventors: Audrey A. Sherman, St. Paul, MN (US); Kevin R. Schaffer, Woodbury, MN (US)

(21) Appl. No.: 13/119,111

(22) PCT Filed: Sep. 16, 2009
(86) PCT No.: PCT/US09/57126

§ 371 Date: Mar. 15, 2011

Related U.S. Application Data
(60) Provisional application No. 61/097,685, filed on Sep. 17, 2008.

(51) Int. Cl. B32B 7/12; C09J 183/04; C09J 133/08; B32B 3/30

(52) U.S. Cl. 428/41.8; 525/100; 428/156; 428/343; 428/355 R; 428/355 AC

(57) ABSTRACT

Disclosed are optically transmissive adhesives that diffuse light which include an optically clear pressure sensitive adhesive matrix and particles dispersed within the matrix with a refractive index less than the refractive index for the pressure sensitive adhesive matrix. The adhesives may be used to prepare optical articles and optical laminates.

### FIELD OF THE DISCLOSURE

The present disclosure relates to adhesives that have optical diffusive properties.

### BACKGROUND

Information displays, such as liquid crystal displays and rear projection screens, often rely on light-diffusing optical constructions for efficient operation and enhanced readability. Such light-diffusing constructions assume critical roles in these displays by forward scattering the light from a source without a significant loss in the intensity of the forward scattered light. This scattered, yet high transmittance, resultant light gives such displays a desirable background brightness by reducing the amount of incident light which is scattered or reflected back toward the light source. Elimination or restriction of such “backscattered” light is a key factor in designing these light-diffusing constructions. Diffusers can be incorporated into optical systems by adding an additional diffuser component to the system, or, in some cases, by incorporating diffusive properties into an existing component.

Adding additional components to an optical system has the disadvantage of introducing additional absorption and creating additional interfaces that can reflect light, thereby causing loss of illumination and other forms of image degradation. Additionally, in some multilayer systems it may be difficult or impossible to add additional components.

### SUMMARY

An optical component layer, such as an adhesive layer, that also can be made to diffuse light is desirable. Disclosed are optically transmissive adhesives which diffuse light, comprising an optically clear pressure sensitive adhesive matrix and particles dispersed within the matrix with a refractive index less than the refractive index for the pressure sensitive adhesive matrix.

Also disclosed are optical articles comprising an optical substrate, and a diffusive adhesive at least partially coated on the optical substrate, wherein the diffusive adhesive comprises an optically clear pressure sensitive adhesive matrix and particles dispersed within the matrix with a refractive index less than the refractive index for the pressure sensitive adhesive matrix. The optical substrate may be for example a release liner, an optical film or a surface of an optical device.

Additionally, optical laminates are disclosed which comprise a substrate and an optical article laminated to the substrate, wherein the optical article comprises an optical film, and a diffusive adhesive at least partially coated on the optical film, wherein the diffusive adhesive comprises an optically clear pressure sensitive adhesive matrix, and particles dispersed within the matrix with a refractive index less than the refractive index for the pressure sensitive adhesive matrix.

### DETAILED DESCRIPTION

An optical component layer, such as an adhesive layer, that also can be made to diffuse light is desirable. In this way the adhesive layer is able to carry out more than one function, i.e. rather than merely adhering two layers together the adhesive is able to carry out the optical function of diffusing light. This is particularly important in multi-layer constructions where a diffusive adhesive layer may aid the function of or even replace a diffusive film layer.

An optical adhesive that also functions to diffuse visible light is disclosed. The diffusive adhesive composition comprises an optically clear adhesive matrix and particles dispersed within the adhesive matrix. The particles have a lower refractive index than the adhesive matrix.

The term “adhesive” as used herein refers to polymeric compositions useful to adhere together two adherends. Examples of adhesives are non-tacky adhesives (i.e., cold-seal adhesives), heat activated adhesives, structural adhesives and pressure sensitive adhesives.

Non-tacky adhesives have limited or low tack to most substrates but can have acceptable adhesive strength when paired with specific target substrates or when two layers of the non-tacky adhesives are contacted. The non-tacky adhesive adheres by affinity.

Heat activated adhesives are non-tacky at room temperature but become tacky and capable of bonding to a substrate at elevated temperatures. These adhesives usually have a Tg or melting point (Tm) above room temperature. When the temperature is elevated above the Tg or Tm, the storage modulus usually decreases and the adhesive become tacky.

Structural adhesives refer to adhesives that that can bond other high strength materials (e.g., wood, composites, or metal) so that the adhesive bond strength is in excess of 6.0 MPa (1000 psi).

Pressure sensitive adhesive (PSA) compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. Obtaining the proper balance of properties is not a simple process.

As used herein the term “diffusive adhesive” or “diffusive pressure sensitive adhesive” refers to an adhesive or pressure sensitive adhesive that is optically transmissive and also diffuses visible light.

As used herein the term “dispersed” refers to particles distributed within a matrix in which the particles may be uniformly or randomly distributed.

Unless otherwise indicated, “optically clear” refers to an adhesive or article that has a high light transmittance over at least a portion of the visible light spectrum (about 400 to about 700 nm), and that exhibits low haze.

Unless otherwise indicated, “optically transmissive” refers to an adhesive or article that has a high light transmittance over at least a portion of the visible light spectrum (about 400 to about 700 nm).

As used herein, the term “polymer” refers to a polymeric material that is a homopolymer or a copolymer. As used herein, the term “homopolymer” refers to a polymeric material that is the reaction product of one monomer. As used herein, the term “copolymer” refers to a polymeric material that is the reaction product of at least two different monomers.

The terms “Tg” and “glass transition temperature” are used interchangeably and refer to the temperature at which a reversible change occurs in an amorphous polymer when it is heated to a certain temperature and it undergoes a rather sudden transition from a hard, glassy, or brittle condition to a flexible or elastomeric condition. Unless otherwise noted Tg values refer to the values measured by Differential Scanning calorimetry (DSC).

The adhesive matrix in the diffusive adhesive composition generally is an optically clear adhesive. In some embodiments, the optically clear adhesive has a % Transmission of 95% or greater, or even 99% or greater. Also, in some embodiments the optically clear adhesive has a haze value of 3% or less, or even 1% or less. In some embodiments the optically clear adhesive has a clarity value of 99% or greater. In some embodiments, the adhesive is an optically clear pressure sensitive adhesive. The pressure sensitive adhesive component can be a single pressure sensitive adhesive or the pressure sensitive adhesive can be a combination of two or more pressure sensitive adhesives.

Optically clear pressure sensitive adhesives useful in the present disclosure include, for example, those based on natural rubbers, synthetic rubbers, styrene block copolymers, (meth)acrylic block copolymers, polyvinyl ethers, polyolefins, and poly(meth)acrylates. The terms (meth)acrylate and (meth)acrylic include both acrylates and methacrylates.

One particularly suitable class of optically clear pressure sensitive adhesives are (meth)acrylate-based pressure sensitive adhesives and may comprise either an acidic or basic copolymer. In many embodiments the (meth)acrylate-based pressure sensitive adhesive is an acidic copolymer. Generally, as the proportion of acidic monomers used in preparing the acidic copolymer increases, cohesive strength of the resulting adhesive increases. The proportion of acidic monomers is usually adjusted depending on the proportion of acidic copolymer present in the blends of the present disclosure.

To achieve pressure sensitive adhesive characteristics, the corresponding copolymer can be tailored to have a resultant glass transition temperature (Tg) of less than about 0° C. Particularly preferred pressure sensitive adhesive copolymers are (meth)acrylate copolymers. Such copolymers typically are derived from monomers comprising about 40% by weight to about 98% by weight, often at least 70% by weight, or at least 85% by weight, or even about 90% by weight, of at least one alkyl(meth)acrylate monomer that, as a homopolymer, has a Tg of less than about 0° C.

Examples of such alkyl(meth)acrylate monomers are those in which the alkyl groups comprise from about 4 carbon atoms to about 12 carbon atoms and include, but are not limited to, n-butyl acrylate, 2-ethylhexyl acrylate, isooctyl acrylate, isononyl acrylate, isodecyl, acrylate, and mixtures thereof. Optionally, other vinyl monomers and alkyl (meth)acrylate monomers which, as homopolymers, have a Tg greater than 0° C., such as methyl acrylate, methyl methacrylate, isobornyl acrylate, vinyl acetate, styrene, and the like, may be utilized in conjunction with one or more of the low Tg alkyl(meth)acrylate monomers and copolymerizable basic or acidic monomers, provided that the Tg of the resultant (meth)acrylate copolymer is less than about 0° C.

In some embodiments, it is desirable to use (meth)acrylate monomers that are free of alkoxy groups. Alkoxy groups are understood by those skilled in the art.

When used, basic (meth)acrylate copolymers useful as the pressure sensitive adhesive matrix typically are derived from basic monomers comprising about 2% by weight to about 50% by weight, or about 5% by weight to about 30% by weight, of a copolymerizable basic monomer.

When used to form the pressure sensitive adhesive matrix, acidic (meth)acrylate copolymers typically are derived from acidic monomers comprising about 2% by weight to about 30% by weight, or about 2% by weight to about 15% by weight, of a copolymerizable acidic monomer.

In certain embodiments, the poly(meth)acrylic pressure sensitive adhesive matrix is derived from between about 1 and about 20 weight percent of acrylic acid and between about 99 and about 80 weight percent of at least one of isooctyl acrylate, 2-ethyl-hexyl acrylate or n-butyl acrylate composition. In some embodiments, the pressure sensitive adhesive matrix is derived from between about 2 and about 10 weight percent acrylic acid and between about 90 and about 98 weight percent of at least one of isooctyl acrylate, 2-ethyl-hexyl acrylate or n-butyl acrylate composition.

Another useful class of optically clear (meth)acrylate-based pressure sensitive adhesives are those which are (meth)acrylic block copolymers. Such copolymers may contain only (meth)acrylate monomers or may contain other co-monomers such as styrenes. Examples of such pressure sensitive adhesives are described, for example in U.S. Pat. No. 7,255,920 (Everaerts et al.).

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, curing agents, polymer additives, thickening agents, chain transfer agents and other additives provided that they do not reduce the optical clarity of the pressure sensitive adhesive.

In some embodiments it is desirable for the composition to contain a crosslinking agent. The choice of crosslinking agent depends upon the nature of polymer or copolymer which one wishes to crosslink. The crosslinking agent is used in an effective amount, by which is meant an amount that is sufficient to cause crosslinking of the pressure sensitive adhesive to provide adequate cohesive strength to produce the desired final adhesion properties to the substrate of interest. Generally, when used, the crosslinking agent is used in an amount of about 0.1 part to about 10 parts by weight, based on the total amount of monomers.

One class of useful crosslinking agents include multifunctional (meth)acrylate species. Multifunctional (meth)acrylates include tri(meth)acrylates and di(meth)acrylates (that is, compounds comprising three or two (meth)acrylate groups). Typically di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

Another useful class of crosslinking agents contain functionality which are reactive with carboxylic acid groups on the acrylic copolymer. Examples of such crosslinkers include multifunctional aziridine, isocyanate and epoxy compounds. Examples of aziridine-type crosslinkers include, for example 1,4-bis(ethyleneiminocarbonylamino)benzene, 4,4′-bis(ethyleneiminocarbonylamino)diphenylmethane, 1,8-bis(ethyleneiminocarbonylamino)octane, and 1,1′-(1,3-phenylene dicarbonyl)-bis-(2-methylaziridine). The aziridine crosslinker 1,1′-(1,3-phenylene dicarbonyl)-bis-(2-methylaziridine) (CAS No. 7652-64-4), referred to herein as “Bisamide” is particularly useful. Common polyfunctional isocyanate crosslinkers include, for example, trimethylolpropane toluene diisocyanate, tolylene diisocyanate, and hexamethylene diisocyanate.

The optically clear pressure sensitive adhesive matrix generally has a refractive index which is higher than the refractive index of the particles which are blended with it. Typically the optically clear pressure sensitive adhesive matrix has a refractive index in the range of about 1.45-1.56. Many pressure sensitive adhesives have refractive indices of 1.47 or less, but recently pressure sensitive adhesives with higher refractive indices, such as at least 1.48 or even at least 1.50 or greater have been prepared, for example as described in U.S. Pat. No. 7,166,686 (Olson et al.).

A variety of different particles are suitable for use in the adhesive matrix to form the diffusive adhesives of this disclosure as long as the particles can withstand the preparation and coating conditions and have a refractive index which is lower than the refractive index for the adhesive matrix. The particles may be in a variety of shapes, but typically the particles are spherical or generally spherically shaped.

Among the classes of particles that are suitable are silicone resin particles, which are sometimes called polymethylsilsesquiloxane particles. Some of these silicone resin particles are crosslinked. It may be desirable for the particles to be crosslinked to avoid dissolving in solvent or mixtures of monomers which may be present with the adhesive matrix.

A range of silicone resin particles are commercially available from Momentive Performance Materials under the trade name “TOSPEARL”. Among the TOSPEARL particles suitable include, for example, TOSPEARL 120, TOSPEARL 120A, TOSPEARL 130, TOSPEARL 130A, TOSPEARL 145, TOSPEARL 145A, TOSPEARL 240, TOSPEARL 3120, TOSPEARL 2000B, TOSPEARL 3000A, TOSPEARL 1110A.

It is desirable that the particle size be large enough to forward scatter incident light, but not so large that they backscatter incident light. Typically these particle sizes are larger than the wavelength of visible light (about 400 to about 700 nm). Typically the particles have an average particle size of greater than about 1 micrometer and less than about 15 micrometers. In some embodiments the average particle size range is from about 2 micrometers to about 8 micrometers, or even about 2 to about 6 micrometers.

The particles may be used in any useful amount but typically at least 0.5 weight % and no more than 25 weight % are added. In some embodiments, at least 1 weight % is added, in other embodiments 2 weight %, 5 weight %, 10 weight % 15 weight % or even 20 weight % may be used.

These particles have desirable refractive indices. Unlike particles typically blended with pressure sensitive adhesives to give diffusive adhesives, the refractive indices of the particles of this disclosure are lower than the refractive indices of the adhesive matrices with which they are blended. Typically these particles have refractive indices in the range of about 1.4-1.5.

The particles used in a given formulation are selected to have a refractive index which is less than the chosen optically clear pressure sensitive adhesive matrix. Additional other criteria, such as particle size, particle loading level and so forth may also be used to control the final performance features of the diffusive adhesive.

The pressure sensitive adhesives of this disclosure are optical adhesives that also function to diffuse visible light without a significant amount of backscattered light. The diffusion of light results in an increase in the level of haze of the adhesive without a major decrease in the % transmission or clarity. Typically the diffusive pressure sensitive adhesives have haze values of 10% or greater as measured by the Test Method listed in the Examples section below. In some embodiments the haze value is 20% or greater. These haze values are obtained for the diffusive pressure sensitive adhesive and yet the adhesive retains % transmission values of 80% or greater, or even 90% or greater and clarity values of 80% or even 90% as measured by the Methods listed in the Examples section below.

The diffusive pressure sensitive adhesives of this disclosure maintain their adhesive properties besides exhibiting desirable optical properties. Typically the diffusive pressure sensitive adhesives have 180° peel strengths of at least 10 Newtons/decimeter when peeled from a glass substrate using the Test Method listed in the Examples section below. In some embodiments the 180° peel strength is at least 20 Newtons/decimeter when peeled from a glass substrate using the Test Method listed in the Examples section below.

Often when pressure sensitive adhesive matrices contain particles, especially fairly rigid particles, the peel adhesion values are typically less, often substantially less than an identical pressure sensitive adhesive matrix without particles. While not wishing to be bound by theory, it is believed that the presence of particles in the adhesive matrix, especially rigid particles, increases the rigidity of the matrix with a consequent decrease in peel strength.

Surprisingly, pressure sensitive adhesive matrices which contain the silicone resin particles of this disclosure have peel adhesion values which are essentially the same as the peel adhesion values for pressure sensitive adhesive matrices which do not contain the silicone resin particles. In general, it has been observed with pressure sensitive adhesives that the addition of particles, especially rigid or relatively hard particles, tends to cause a decrease in the peel adhesion of the pressure sensitive adhesive.

Typically the peel adhesion values of the pressure sensitive adhesive with particles of the present disclosure are greater than 90% of the value of the peel adhesion of the pressure sensitive adhesive without particles. In some embodiments the peel adhesion values of the pressure sensitive adhesive with particles are greater than 95% of the value of the peel adhesion of the pressure sensitive adhesive without particles, or 97%, 99% or even 100%.

In some embodiments, the diffusive pressure sensitive adhesives are environmentally resistant. Environmentally resistant adhesives are those that maintain adhesive bonds when bonded to substrates, especially outgassing substrates (outgassing substrates are described below), and tested under accelerated aging conditions. Among the accelerated aging conditions useful for testing diffusive pressure sensitive adhesives bonded to substrates include, for example, aging for one week at 95° C. and 95% Relative Humidity (RH). Generally, to pass the accelerated aging tests, the adhesive bond does not exhibit delamination or bubbles in the bond line.

The optically clear pressure sensitive adhesive matrix may be prepared by any conventional polymerization technique useful to prepare such adhesives. When the adhesive matrix is a (meth)acrylate copolymer, the copolymers can be prepared by any conventional free radical polymerization method, including solution, radiation, bulk, dispersion, emulsion, and suspension processes. In one solution polymerization method, the monomers, along with a suitable inert organic solvent, are charged into a four-neck reaction vessel that is equipped with a stirrer, a thermometer, a condenser, an addition funnel, and a temperature controller.

A concentrated thermal free radical initiator solution is added to the addition funnel. The whole reaction vessel, addition funnel, and their contents are then purged with nitrogen to create an inert atmosphere. Once purged, the solution within the vessel is heated to an appropriate temperature to activate the free radical initiator to be added, the initiator is added, and the mixture is stirred during the course of the reaction. A 98% to 99% conversion can typically be obtained in about 20 hours.

Bulk polymerization methods, such as the continuous free radical polymerization method described by Kotnour et al. in U.S. Pat. Nos. 4,619,979 and 4,843,134; the essentially adiabatic polymerization methods using a batch reactor described by Ellis in U.S. Pat. No. 5,637,646; suspension polymerization processes described by Young et al. in U.S. Pat. No. 4,833,179; and, the methods described for polymerizing packaged pre-adhesive compositions described by Hamer et al. in PCT Publication No. WO 97/33945 may also be utilized to prepare the polymers.

Suitable thermal free radical initiators which may be utilized include, but are not limited to, those selected from azo compounds, such as 2,2′-azobis(isobutyronitrile); hydroperoxides, such as tert-butyl hydroperoxide; and, peroxides, such as benzoyl peroxide and cyclohexanone peroxide. Photoinitiators which are useful include, but are not limited to, those selected from benzoin ethers, such as benzoin methyl ether or benzoin isopropyl ether; substituted benzoin ethers, such as anisole methyl ether; substituted acetophenones, such as 2,2-diethoxyacetophenone and 2,2-dimethoxy-2-phenyl acetophenone; substituted alpha-ketols, such as 2-methyl-2-hydroxy propiophenone; aromatic sulfonyl chlorides, such as 2-naphthalene sulfonyl chloride; and, photoactive oximes, such as 1-phenyl-1,2-propanedione-2-(ethoxycarbonyl)oxime. For both thermal- and radiation-induced polymerizations, the initiator is present in an amount of about 0.05% to about 5.0% by weight based upon the total weight of the monomers.

Both solventless and solvent borne techniques may be used to coat the diffusive adhesive compositions. For solventless embodiments, the adhesive is typically prepared by a coat and cure technique. In this technique a coatable mixture is coated on a web and then subjected to curing, generally photochemically. The web may be a backing, substrate, release liner or the like. If the coatable mixture contains only monomers, the viscosity may not be sufficiently high to be readily coatable. Several techniques may be used to generate a mixture with a coatable viscosity. A viscosity modifying agent may be added such as high or relatively high molecular weight species or thixotropic agents such as colloidal silicas, etc. Alternatively the monomer mixture can be partially prepolymerized to give a coatable syrup as described in, for example, U.S. Pat. No. 6,339,111 (Moon, et al.).

The particles may be dispersed within the adhesive matrix at any stage of this process prior to coating and curing. For example, the particles may be dispersed in the monomer mixture, in the monomer mixture with added modifying agent or to the coatable syrup. For ease of dispersal, the particles are typically added to the monomer mixture or the coatable syrup.

An initiator or initiators may be used to prepare a coatable syrup as well as to initiate polymerization of the adhesive matrix polymer after coating. These initiators may be the same or different, and each initiator may be a thermal initiator or a photoinitiator. Typically, for ease of processing, photoinitiators are used. Examples of useful photoinitiators include benzoin ethers such as benzoin methyl ether and benzoin isopropyl ether; substituted phosphine oxides such as 2,4,6-trimethylbenzoyldiphenylphosphine oxide available as LUCIRIN TPO-L (BASF); substituted acetophenones such as 2,2-diethoxyacetophenone, available as IRGACURE 651 photoinitiator (Ciba; Ardsley, N.Y.), 2,2-dimethoxy-2-phenyl-1-phenylethanone, available as ESACURE KB-1 photoinitiator (Sartomer Co.; West Chester, Pa.), and dimethoxyhydroxyacetophenone; substituted α-ketols such as 2-methyl-2-hydroxy propiophenone; such as 2-naphthalene-sulfonyl chloride; such as 1-phenyl-1,2-propanedione-2-(O-ethoxy-carbonyl)oxime. Particularly useful are the substituted acetophenones or 2,4,6-trimethylbenzoyldiphenylphosphine oxide.

While solventless embodiments are visualized within the scope of this disclosure, in embodiments where the adhesive matrix is prepared and blended with particles as opposed to the cast and cure techniques just described, it is typically preferred that solvents are used in blending and coating the diffusive adhesive compositions. In particular, solventless coating methods such as hot melt coating have been observed to cause orientation in the adhesive coating and this orientation can cause optical birefringence (see for example PCT Publication Number WO 97/22675). Optical birefringence is the resolution or splitting of a light wave into two unequally reflected or transmitted waves by an optically anisotropic medium. Suitable solvents include ethyl acetate, acetone, methyl ethyl ketone, heptane, toluene, and alcohols such as methanol, ethanol and isopropanol and mixtures thereof. If used, the amount of solvent is generally about 30-80% by weight based on the total weight of the components (polymers, crosslinkers and any additives) and solvent. The particles may be mixed with the solvent mixture using any convenient mixing or blending technique such as hand stirring, mechanical stirring, mechanical mixing, mechanical shaking and the like.

The solvent borne diffusive adhesive mixture can be coated by any suitable process, such as by, for example, knife coating, roll coating, gravure coating, rod coating, curtain coating, and air knife coating. The diffusive adhesive mixture may also be printed by known methods such as screen printing or inkjet printing. The diffusive adhesive coating is typically then dried to remove the solvent. In some embodiments the coating is subjected to increased temperatures such as supplied by an oven (e.g. a forced air oven) in order to expedite the drying of the adhesive.

In some embodiments it may be desirable to impart a microstructured surface to one or both major surfaces of the adhesive. It may be desirable to have a microstructured surface on at least one surface of the adhesive to aid air egress during lamination. If it is desired to have a microstructured surface on one or both surfaces of the adhesive layer, the adhesive coating or layer may be placed on a tool or a liner containing microstructuring. The liner or tool can then be removed to expose an adhesive layer having a microstructured surface. Generally with optical applications it is desirable that the microstructure disappear over time to prevent interference with optical properties.

The diffusive adhesive may be used to make optical articles. Such articles may include an optical film, a substrate or both. The diffusive adhesive is particularly useful in applications in which a separate diffuser layer or film is currently used. Diffusive layers are used, for example, in applications where there is a point light source such as a light bulb or an LED, or a series of such point light sources, and it is desirable to diffuse the light from the point source to produce a desirable background brightness. Such uses include information displays, such as liquid crystal displays, light boxes for graphic displays, and rear projection screens.

Articles are provided that include an optical film and a diffusive pressure sensitive adhesive layer adjacent to at least one major surface of the optical film. The articles can further include another substrate (e.g., permanently or temporarily attached to the pressure sensitive adhesive layer), another adhesive layer, or a combination thereof. As used herein, the term “adjacent” can be used to refer to two layers that are in direct contact or that are separated by one or more layers. Often, adjacent layers are in direct contact.

Additionally, articles are provided that include a pressure sensitive adhesive layer positioned between two substrates, wherein at least one of the substrates is an outgassing substrate. The pressure sensitive adhesive layer is resistant to bubble formation when adjacent to an outgassing substrate.

In some embodiments, the resulting articles can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, screens or displays, cathode ray tubes, polarizers, reflectors, light boxes for graphic displays and signs, and the like.

Any suitable optical film can be used in the articles. As used herein, the term “optical film” refers to a film that can be used to produce an optical effect. The optical films are typically polymer-containing films that can be a single layer or multiple layers. The optical films are flexible and can be of any suitable thickness. The optical films often are at least partially transmissive, reflective, antireflective, polarizing, optically clear, or diffusive with respect to some wavelengths of the electromagnetic spectrum (e.g., wavelengths in the visible, ultraviolet, or infrared regions of the electromagnetic spectrum). Exemplary optical films include, but are not limited to, visible mirror films, color mirror films, solar reflective films, infrared reflective films, ultraviolet reflective films, reflective polarizer films such as a brightness enhancement films and dual brightness enhancement films, absorptive polarizer films, optically clear films, tinted films, graphic films (both translucent and transparent), and antireflective films.

Some optical films have multiple layers such as multiple layers of polymer-containing materials (e.g., polymers with or without dyes) or multiple layers of metal-containing material and polymeric materials. Some optical films have alternating layers of polymeric material with different indexes of refraction. Other optical films have alternating polymeric layers and metal-containing layers. Exemplary optical films are described in the following patents: U.S. Pat. No. 6,049,419 (Wheatley et al.); U.S. Pat. No. 5,223,465 (Wheatley et al.); U.S. Pat. No. 5,882,774 (Jonza et al.); U.S. Pat. No. 6,049,419 (Wheatley et al.); U.S. Pat. No. RE 34,605 (Schrenk et al.); U.S. Pat. No. 5,579,162 (Bjornard et al.), and U.S. Pat. No. 5,360,659 (Arends et al.).

The substrate included in the article can contain polymeric materials, glass materials, ceramic materials, metal-containing materials (e.g., metals or metal oxides), or a combination thereof. The substrate can include multiple layers of material such as a support layer, a primer layer, a hard coat layer, a decorative design, and the like. The substrate can be permanently or temporarily attached to an adhesive layer. For example, a release liner can be temporarily attached and then removed for attachment of the adhesive layer to another substrate.

The substrate can have a variety of functions such as, for example, providing flexibility, rigidity, strength or support, reflectivity, antireflectivity, polarization, or transmissivity (e.g., selective with respect to different wavelengths). That is, the substrate can be flexible or rigid; reflective or non-reflective; visibly clear, colored but transmissive, graphic (i.e. have a printed image or indicia), or opaque (e.g., not transmissive); and polarizing or non-polarizing.

Exemplary substrates include, but are not limited to, the outer surface of an electronic display such as liquid crystal display or a cathode ray tube, the outer surface of a window or glazing, the outer surface of an optical component such as a reflector, polarizer, diffraction grating, mirror, or lens, another film such as a graphic or decorative film or another optical film, or the like.

Representative examples of polymeric substrates include those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes and polypropylenes, polyvinyl chlorides, polyimides, cellulose triacetates, acrylonitrile-butadiene-styrene copolymers, and the like.

Some polymeric substrates undergo a phenomenon referred to as “outgassing” or “out-gas releasing”. For example, rigid layers such as poly(meth)acrylates, polycarbonates, and the like tend to outgas, particularly when they are relatively thick (e.g., in the range of about 1 millimeter to several centimeters). Outgassing substrates can adversely affect the stability, clarity, bond strength, or other desirable performance characteristics of an adhesive layer adjacent to these substrates. Applying an incompatible adhesive layer to an outgassing substrate may result in defects such as bubbles. Additionally, applying an incompatible adhesive layer to an outgassing substrate may also result in partial or full delamination of the adhesive bond between the outgassing substrate and another layer such as an optical film.

Outgassing can be particularly adverse when the other layer bonded to the outgassing substrate through the adhesive layer exhibits low moisture transmissivity. At least some optical films have a low moisture transmissivity. The low moisture transmissivity layer can act as a barrier to the release of the gas resulting in the accumulation of gas at the adhesive interface or within the adhesive layer. The accumulated gas can contribute to bubbling, delamination, reduced bond strength, loss of clarity, or a combination thereof. The diffusive pressure sensitive adhesives of this disclosure can often be used in applications with outgassing substrates.

In other embodiments, the substrate is a release liner. Any suitable release liner can be used. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like). At least some release liners are coated with a layer of a release agent such as a silicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film. The liner can have a microstructure on its surface that is imparted to the adhesive to form a microstructure on the surface of the adhesive layer. The liner can then be removed to expose an adhesive layer having a microstructured surface.

The release liner can be removed to adhere the optical film to another substrate (i.e., removal of the release liner exposes a surface of an adhesive layer that subsequently can be bonded to another substrate surface). Often, the adhesive layer is permanently bonded to this other substrate.

The thickness of the adhesive layer in the articles of invention tends to be at least about 1 micrometer, at least 5 micrometers, at least 10 micrometers, at least 15 micrometers, or at least 20 micrometers. The thickness is often no greater than about 200 micrometers, no greater than about 175 micrometers, no greater than about 150 micrometers, or no greater than about 125 micrometers. For example, the thickness can be 1 to 200 micrometers, 5 to 100 micrometers, 10 to 50 micrometers, 20 to 50 micrometers, or 1 to 15 micrometers.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

Table of Abbreviations

| Abbreviation | |
|---|---|
| or Trade | |
| Designation | Description |
| PSA-1 | A pressure sensitive adhesive syrup mixture containing |
| | the monomers IOA/IBA/AA in a ratio (by weight) |
| | of 85/14/1, and also containing 0.05% by weight HDDA |
| | and 1.0% initiator (LUCIRIN TPO-L from BASF) as |
| | described in U.S. Pat. No. 6,339,111 (Moon, et al.). |
| PSA-2 | A solution polymerized pressure sensitive adhesive |
| | containing 95 parts IOA and 5 parts AA, 28% solids in ethyl |
| | acetate, prepared as described in U.S. Pat. No. RE 24,906 |
| | (Ulrich) and crosslinked with bisamide crosslinker. |
| Particle-1 | Silicone resin powder with 2 micrometer average particle size, |
| | commercially available as TOSPEARL 120 from Momentive |
| | Performance Materials, Wilton, CT. |
| Particle-2 | Silicone resin powder with 4.5 micrometer average particle |
| | size, commercially available as TOSPEARL 145 from |
| | Momentive Performance Materials, Wilton, CT. |
| Particle-3 | Silicone resin powder commercially available as TOSPEARL |
| | 3120 from Momentive Performance Materials, Wilton, CT. |
| Particle-4 | Silicone resin powder with 6 micrometer average particle size, |
| | commercially available as TOSPEARL 2000B from |
| | Momentive Performance Materials, Wilton, CT. |
| Bisamide | Aziridine crosslinker, 1,1′-(1,3-phenylene dicarbonyl)-bis-(2- |
| | methylaziridine) (CAS No. 7652-64-4). |
| IOA | Iso-octyl acrylate |
| IBA | Iso-bornyl acrylate |
| AA | Acrylic acid |
| HDDA | 1,6-Hexanediol diacrylate |
| PET Film | a primed polyester film of polyethylene terephthalate, |
| | 51 micrometers thick |

### Test Methods

### Luminous Transmission and Haze Test

The luminous transmittance and haze of all samples were measured according to American Society for Testing and Measurement (ASTM) Test Method D 1003-95 5 (“Standard Test for Haze and Luminous Transmittance of Transparent Plastic”) using a Hazegard Plus Spectrophotometer from BYK-Gardner Inc.; Silver Springs, Md. The adhesive samples were prepared by transferring the adhesive from a release liner to a glass microscope slide and covering the adhesive with clear PET Film of 51 micrometers (2 mils) thickness.

### Clarity Test

Optical clarity was determined using a transmission accessory mounted on a spectrophotometer (commercially available from BYK Gardner, Columbia, Md. under the trade designation Hazegard Plus). The adhesive samples were prepared by coating the adhesive on a polypropylene film of 25 or 51 micrometers (1 or 2 mils) thickness and laminating the samples to a glass microscope slide.

### 180° Peel Force Testing

This peel adhesion test is similar to the test method described in ASTM D 3330-90, substituting a glass plate as the substrate. Adhesive samples coated on a liner were transferred to PET Film and samples were cut into 1.27 centimeter by 15 centimeter strips. Each strip was then adhered to a 10 centimeter by 20 centimeter clean substrate. The strip was adhered by passing a 2-kilogram roller over the strip. The bonded assembly dwelled for about 1 minute and was tested for 180° peel adhesion using an IMASS slip/peel tester (Model 3M90, commercially available from Instrumentors Inc., Strongsville, Ohio) at a rate of 30 centimeters/minute (12 inches/minute) over a five second data collection time. Measurements were obtained in ounces/inch and converted to Newtons per decimeter.

### Examples 1-3

Samples of pressure sensitive adhesive with particles were prepared by mixing in a jar PSA-1 and the amount of Particle-1 shown in Table 1. The 100% solids monomer syrup with the particles were stirred by hand with a glass rod and then mixed on a roller for 8 hours. The samples were coated on a release liner to a thickness of 51 micrometers (2 mils) and cured under UV lights with “B” bulbs from General Electric, Schenectady, N.Y. The Luminous Transmission, Haze, Clarity, and 180° Peel Force were measured using the Test Methods described above. The data are presented in Table 1 below.

### Examples 4-6

Samples of pressure sensitive adhesive with particles were prepared by mixing in a jar PSA-1 and the amount of Particle-2 shown in Table 1. The 100% monomer syrup with the particles were stirred by hand with a glass rod and then mixed on a roller for 8 hours. The samples were coated on a release liner to a thickness of 51 micrometers (2 mils) and cured under UV lights with “B” bulbs from General Electric, Schenectady, N.Y. The Luminous Transmission, Haze, Clarity, and 180° Peel Force were measured using the Test Methods described above. The data are presented in Table 1 below.

### Examples 7-9

Samples of pressure sensitive adhesive with particles were prepared by mixing in a jar PSA-1 and the amount of Particle-3 shown in Table 1. The 100% monomer syrup with the particles were stirred by hand with a glass rod and then mixed on a roller for 8 hours. The samples were coated on a release liner to a thickness of 51 micrometers (2 mils) and cured under UV lights with “B” bulbs from General Electric, Schenectady, N.Y. The Luminous Transmission, Haze, Clarity, and 180° Peel Force were measured using the Test Methods described above. The data are presented in Table 1 below.

### Comparative Example C1

A sample of PSA-1 was coated and cured as described in Examples 1-3 above and tested for Luminous Transmission, Haze, Clarity, and 180° Peel Force using the Test Methods described above. The data are presented in Table 1 below.

TABLE 1

| | | | Trans- | | | |
|---|---|---|---|---|---|---|
| | Particle | Particle | mission | Haze | Clarity | 180° Peel |
| Example | (wt %) | Identity | (%) | (%) | (%) | (N/dm) |
| 1 | 1 | 1 | 90.9 | 23.6 | 98.0 | 151.9 |
| 2 | 5 | 1 | 90.3 | 56.1 | 94.6 | 148.2 |
| 3 | 10 | 1 | 90.0 | 80.0 | 87.2 | 53.0 |
| 4 | 1 | 2 | 91.1 | 13.0 | 96.1 | 121.1 |
| 5 | 5 | 2 | 89.8 | 58.3 | 78.8 | 150.6 |
| 6 | 10 | 2 | 89.8 | 82.4 | 51.9 | 135.1 |
| 7 | 1 | 3 | 91.0 | 7.45 | 97.5 | 152.8 |
| 8 | 5 | 3 | 90.7 | 23.3 | 91.7 | 143.6 |
| 9 | 10 | 3 | 90.7 | 36.7 | 85.5 | 144.9 |
| C1 | 0 | — | 91.3 | 2.14 | 99.3 | 101.8 |

### Examples 10-22 and Comparative Example C2

For Examples 10-22, a series of adhesive samples were prepared by mixing PSA-2, with Particle-1 and/or Particle-4 in a jar and coated on a release liner to a thickness of 51 micrometers (2 mils), and then crosslinked. For Comparative Example C2 no particles were added. The amounts and identities of the added particles are shown in Table 2. The adhesive samples were tested for Luminous Transmission, Haze, Clarity and 180° Peel Force using the Test Methods described above, the data are presented in Table 2.

TABLE 2

| | | | Trans- | | | |
|---|---|---|---|---|---|---|
| | Particle-1 | Particle-4 | mission | Haze | Clarity | Peel |
| Example | (wt %) | (wt %) | (%) | (%) | (%) | (N/dm) |
| C2 | 0 | 0 | 96.6 | 0.93 | 99.2 | 6.5 |
| 10 | 10 | 0 | 93.9 | 56.0 | 96.3 | 10.4 |
| 11 | 20 | 0 | 93.7 | 79.2 | 92.8 | 5.9 |
| 12 | 0 | 20 | 93.2 | 79.4 | 41.4 | 10.1 |
| 13 | 6 | 7 | 93.6 | 69.1 | 81.0 | 8.0 |
| 14 | 10 | 10 | 93.4 | 73.7 | 63.1 | 10.8 |
| 15 | 4 | 3 | 94.0 | 39.7 | 93.0 | 6.6 |
| 16 | 0 | 10 | 93.8 | 47.3 | 82.1 | 8.3 |
| 17 | 5 | 0 | 94.2 | 30.1 | 90.9 | 11.3 |
| 18 | 0 | 5 | 94.3 | 26.9 | 92.1 | 8.4 |
| 19 | 0 | 15 | 93.4 | 67.8 | 63.2 | 11.2 |
| 20 | 15 | 0 | 93.7 | 69.0 | 94.8 | 16.5 |
| 21 | 5 | 15 | 93.1 | 80.1 | 55.5 | 9.6 |
| 22 | 15 | 5 | 93.4 | 86.7 | 86.7 | 15.4 |

1. An optically transmissive adhesive comprising:
an optically clear pressure sensitive adhesive matrix; and
particles dispersed within the matrix with a refractive index less than the refractive index for the pressure sensitive adhesive matrix.

2. The adhesive of claim 1 wherein the particles comprise silicone resin particles.

3. The adhesive of claim 1 wherein the particles comprise crosslinked silicone resin particles.

4. The adhesive of claim 1 wherein the particles have a refractive index of 1.4-1.5.

5. The adhesive of claim 1 wherein the pressure sensitive adhesive matrix has a refractive index of 1.45-1.56.

6. The adhesive of claim 1 wherein the adhesive matrix comprises a (meth)acrylate copolymer pressure sensitive adhesive, a block copolymer pressure sensitive adhesive, a natural rubber pressure sensitive adhesive or a mixture thereof.

7. The adhesive of claim 1 wherein the adhesive matrix comprises a (meth)acrylate copolymer pressure sensitive adhesive.

8. The adhesive of claim 1 wherein the adhesive has a haze value of greater than 10% and an optical transmission (% T) of greater than 80%.

9. (canceled)

10. The adhesive of claim 1 wherein the adhesive further comprises a microstructured pattern.

11. (canceled)

12. An optical article comprising:
an optical substrate; and
a diffusive adhesive at least partially coated on the optical substrate, wherein the diffusive adhesive comprises an optically clear pressure sensitive adhesive matrix; and particles dispersed within the matrix with a refractive index less than the refractive index for the pressure sensitive adhesive matrix.

13. The optical article of claim 12 wherein the optical substrate comprises: a release liner, an optical film, or an outer surface of an electronic device.

14. The optical article of claim 13 wherein the optical film comprises:
a visible mirror film, a color mirror film, a solar reflective film, an infrared reflective film, an ultraviolet reflective film, a reflective polarizer film such as a brightness enhancement film or a dual brightness enhancement film, an absorptive polarizer film, an optically clear film, a tinted film, a graphic film, an antireflective film or a diffusive film.

15. The optical article of claim 12 wherein the particles comprise silicone resin particles.

16. The optical article of claim 12 wherein the particles have a refractive index of 1.4-1.5.

17. (canceled)

18. The optical article of claim 12 wherein the optically clear pressure sensitive adhesive matrix comprises a (meth)acrylate copolymer pressure sensitive adhesive, a block copolymer pressure sensitive adhesive, a natural rubber pressure sensitive adhesive or a mixture thereof.

19. The optical article of claim 12 wherein the diffusive adhesive further comprises a crosslinking agent.

20. An optical laminate comprising:
a substrate; and
an optical article laminated to the substrate, wherein the optical article comprises:
an optical film; and
a diffusive adhesive at least partially coated on the optical film, wherein the diffusive adhesive comprises an optically clear pressure sensitive adhesive matrix, and particles dispersed within the matrix with a refractive index less than the refractive index for the pressure sensitive adhesive matrix.

21. The optical laminate of claim 20 wherein the substrate comprises: a release liner, an optical film, or the outer surface of an electronic device.

22. The optical laminate of claim 20 wherein the particles comprise silicone resin particles.

23. The optical laminate of claim 20 wherein the thermoplastic particles have a refractive index of 1.4-1.5.

24. (canceled)

25. (canceled)
